(19) United States
(12) Patent Application Publication
(10) Pub. No.: US 2023/0331295 A1
(43) Pub. Date: Oct. 19, 2023

(54) HIGHLY MANEUVERABLE VEHICLE

(71) Applicant: Paha Designs, LLC, Felt, ID (US)

(72) Inventor: Benjamin Meager, Felt, ID (US)

(21) Appl. No.: 18/133,131

(22) Filed: Apr. 11, 2023

Related U.S. Application Data
(60) Provisional application No. 63/330,369, filed on Apr. 13, 2022.

(51) Int. Cl. B62D 9/00; B62D 7/04; B60K 1/02; B60W 60/00

(52) U.S. Cl. CPC B62D 7/04; B60K 1/02; B60W 60/00; B62D 9/002

(57) ABSTRACT

A vehicle and steering system for a vehicle are described. The vehicle is described to include a frame and a first set of wheels configured to rotate about a first rotational axis. Each wheel in the first set of wheels is independently motor controlled and pivotably mounted to the frame such that the first set of wheels spin about a first steering axis. The first steering axis may be orthogonal to the first rotational axis.

### CROSS-REFERENCE TO RELATED APPLICATION

The present application claims the benefit of U.S. Provisional Pat. Application No. 63/330,369, filed on Apr. 13, 2022, the entire contents of which are hereby incorporated herein by reference in its entirety.

### FIELD

The present disclosure relates generally to the field of vehicles. More specifically, it relates to vehicles with improved maneuverability.

### BACKGROUND

Vehicle steering systems have developed over the years. The most common type of steering on cars, small trucks, and Sports Utility Vehicles (SUVs) is the rack-and-pinion steering. The purpose of rack-and-pinion steering is to convert rotation motion of a steering wheel into the linear motion needed to turn wheels of the vehicle. Another type of commonly available steering is skid steering, which is normally found on tracked vehicles such as tractors, tanks, bulldozers, and other industrial equipment. As compared to rack-and-pinion steering, the skid steering synchronizes the rotation of the vehicle’s front and rear wheels. Steering with a skid steering system is accomplished by actuating the wheels on each side of the vehicle at a different rate or in a different direction, causing the wheels or tracks to slip (e.g., “skid”) on the ground. Skid steering facilitates vehicle maneuvering in tight spaces, but provides the risk of damaging the ground (e.g., due to the skidding of the wheels or tracks over the ground). Rack-and-pinion steering helps to avoid the undesirable ground damage, but does not provide the same level of maneuverability that skid steering provides.

### SUMMARY

Embodiments of the present disclosure aim to provide a steering system for a vehicle that overcomes the damage normally caused by skid steering systems, while providing better maneuverability than rack-and-pinion systems or other traditional vehicle steering system.

In some embodiments, a vehicle is provided that includes: a frame; and a first set of wheels configured to rotate about a first rotational axis, where each wheel in the first set of wheels is independently motor controlled, where the first set of wheels are pivotably mounted to the frame such that the first set of wheels spin about a first steering axis, and where the first steering axis is orthogonal to the first rotational axis.

According to another embodiment of the present disclosure, a steering system is provided that includes: a rotatable mount connected to a frame of the vehicle, where the rotatable mount pivots about a steering axis; and a first set of wheels that are independently motor controlled and connected to the rotatable mount, where the first set of wheels are configured to rotate about a rotational axis that is orthogonal to the steering axis.

### BRIEF DESCRIPTION OF THE DRAWINGS

The present disclosure is described in conjunction with the appended figures, which are not necessarily drawn to scale:

FIG. 1 is an isometric view of a vehicle in a first position in accordance with at least some embodiments of the present disclosure;

FIG. 2 is a top view of the vehicle depicted in FIG. 1;

FIG. 3 is an isometric view of a vehicle in a second position in accordance with at least some embodiments of the present disclosure;

FIG. 4 is an isometric view of a vehicle in a third position in accordance with at least some embodiments of the present disclosure;

FIG. 5 is an isometric view of a vehicle in a fourth position in accordance with at least some embodiments of the present disclosure;

FIG. 6 is an isometric view of a vehicle in a fifth position in accordance with at least some embodiments of the present disclosure;

FIG. 7A is a front view of a set of wheels in accordance with at least some embodiments of the present disclosure;

FIG. 7B is an isometric view of the set of wheels depicted in FIG. 7A;

FIG. 8A is a front view of a wheel in accordance with at least some embodiments of the present disclosure;

FIG. 8B is an isometric view of the wheel depicted in FIG. 8A;

FIG. 9 is a block diagram depicting components of a vehicle and system for controlling the vehicle in accordance with at least some embodiments of the present disclosure; and

FIG. 10 is a block diagram depicting another configuration of components of a vehicle and system for controlling the vehicle in accordance with at least some embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. Various changes may be made in the function and arrangement of elements without departing from the spirit and scope of the appended claims.

Various examples are provided throughout the following disclosure. The disclosure of examples is in all cases intended to be non-limiting, including specifically when examples are identified with the terms or phrases identifying what follows to be an example, including the terms of phrases “for example,” “as one example,” “such as,” “by way of example,” and “e.g.” In other words, the disclosure of one or more examples is not intended to limit the present disclosure to embodiments conforming to the disclosed example(s).

Embodiments of vehicles disclosed herein may include any number of features. While various examples of vehicles and methods of refueling vehicles will be described with particular features, it should be appreciated that the features depicted and described in connection with a particular vehicle may be used in another vehicle or refueling system without departing from the scope of the present disclosure. Further still, embodiments of the present disclosure contemplate that vehicle wheels or sets of wheels may be easily replaced by other wheels or sets of wheels. Thus, embodiments of the present disclosure contemplate that wheels of one type may be used to replace wheels of another type.

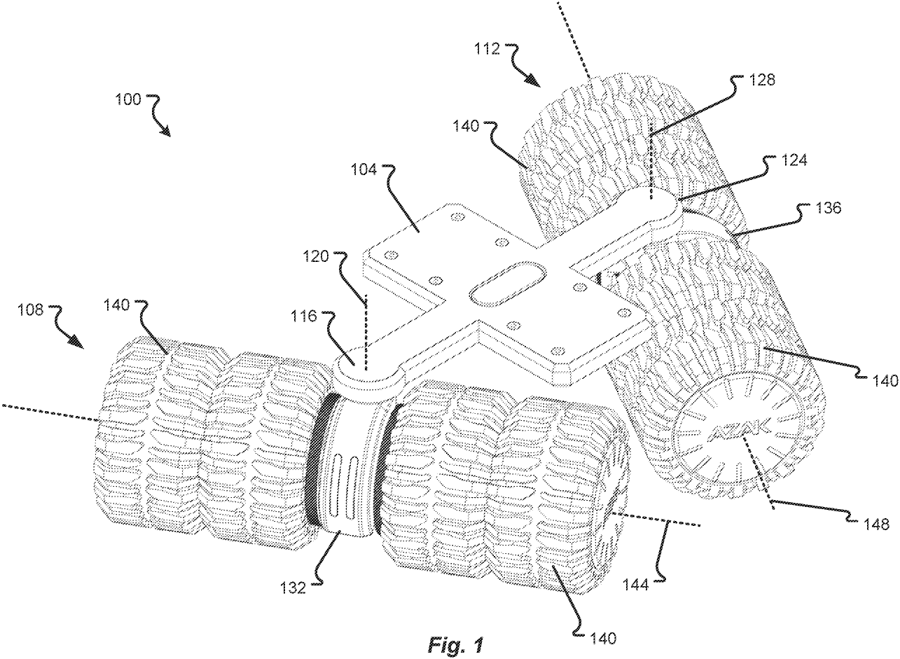

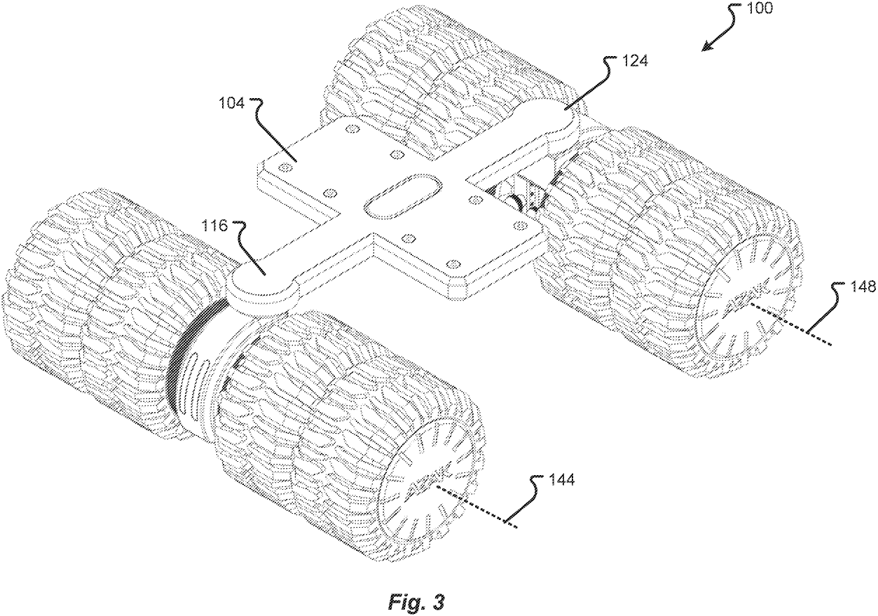

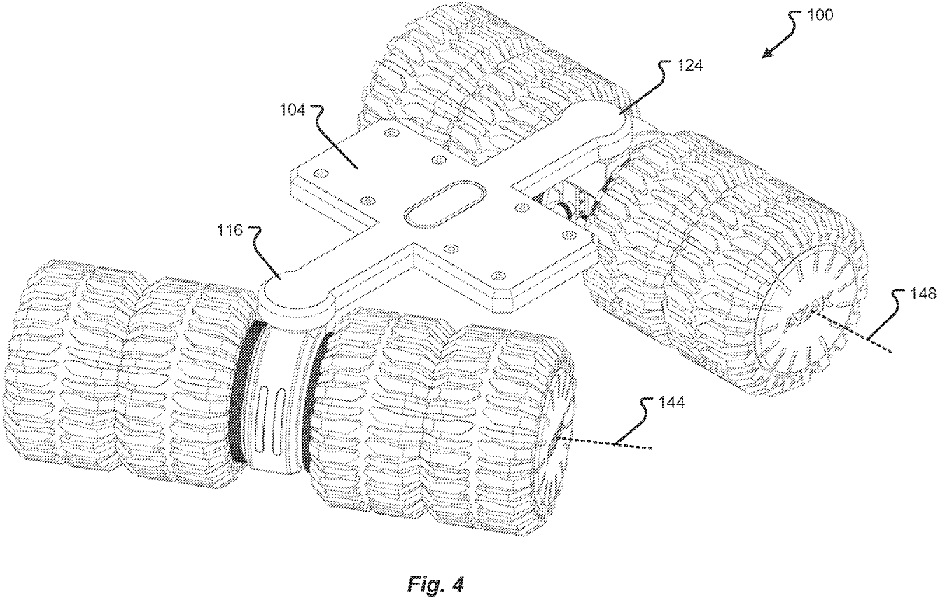

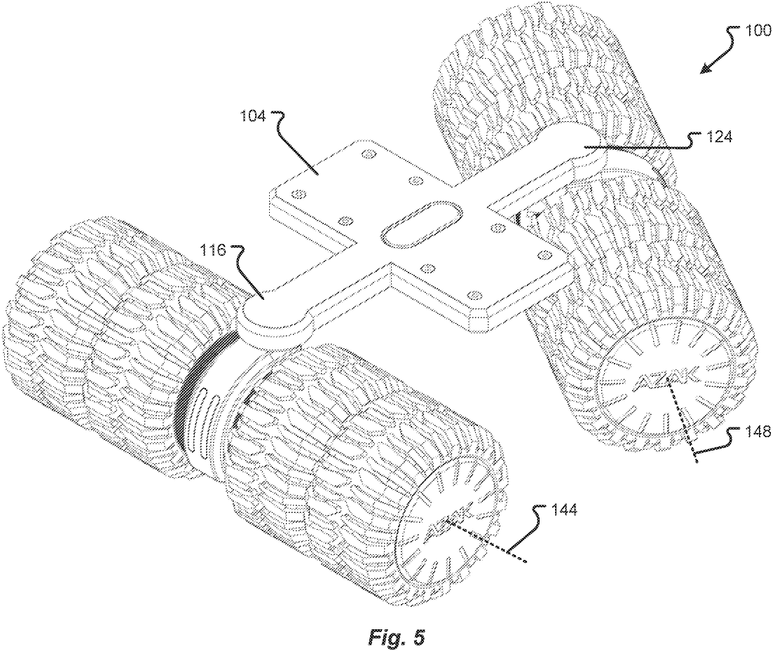

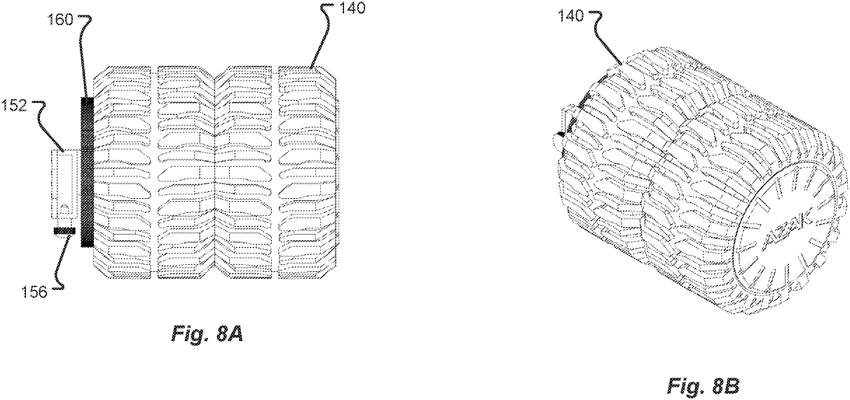

Referring now to FIG. 1-8B, various details of a vehicle 100 and components thereof will be described in accordance with at least some embodiments of the present disclosure. The vehicle 100 is shown to include a frame 104 supported by a first set of wheels 108 and a second set of wheels 112. The first set of wheels 108 are mounted to the frame 104 via a first rotatable mount 132 and the second set of wheels 112 are mounted to the frame 108 via a second rotatable mount 136.

The first rotatable mount 132 may be connected to the frame 104 at a first frame end 116 and the second rotatable mount 136 may be connected to the frame 104 at a second frame end 124. The first frame end 116 may be located opposite the second frame end 124. The body of the frame 104 may correspond to the remaining portion of the frame 104 that resides between the first frame end 116 and the second frame end 124. In some embodiments, the frame 104 may be configured to support a load. For example, the frame 104 may be configured to support a payload that includes people, animal cargo, inanimate cargo, physical objects, liquid objects, etc.

In some embodiments, the vehicle 100 may be configured to operate autonomously, semi-autonomously, or under remote control by a human operator. Alternatively, the vehicle 100 can be operated by direct human control (e.g., as a drivable passenger vehicle in which the human is a passenger and controls the vehicle 100 while being carried by the vehicle 100). The vehicle 100 can be configured to operate in an industrial setting, in an agricultural setting, in a residential setting, or the like. Illustratively, but without limitation, the vehicle 100 can be configured to move around a distribution center or the like and may support objects that are being loaded or unloaded for order fulfillment.

As shown in FIG. 1, the first rotatable mount 132 may rotate about the first frame end 116 around a first steering axis 120. The second rotatable mount 136 may rotate about the second frame end 124 around a second steering axis 128. The first steering axis 120 and second steering axis 128 may be parallel with one another. In some embodiments, both the first steering axis 120 and the second steering axis 128 are perpendicular to ground and perpendicular to a top surface of the frame 104.

The first rotatable mount 132 may support the first set of wheels 108 and the second rotatable mount 136 may support the second set of wheels 112. The first set of wheels 108 may include a left wheel 140 and a right wheel 140. In some embodiments, the first set of wheels 108 may include more than two wheels 140. For example, the first set of wheels 108 may include two, three, four or more wheels 140. Similarly, the second set of wheels 112 may include a left wheel 140 and a right wheel 140. In some embodiments, the second set of wheels 112 may include more than two wheels 140. For example, the second set of wheels 112 may include two, three, four or more wheels 140.

Referring initially to the first set of wheels 108, the first rotatable mount 132 may have the left wheel 140 mounted directly thereto on its left side while the right wheel 140 is mounted directly to the first rotatable mount 132 on its right side. Both wheels 140 may be self-propelled, meaning that each wheel 140 includes an internal motor and motor controller. In some embodiments, the motor controllers of each wheel 140 may be coordinated together, either by a shared logic or by a centralized coordination that is delegated to one of the wheel’s 140 controllers. Each wheel 140 in the first set of wheels 108 may be configured to rotate about a first rotational axis 144. The first rotational axis 144 may bisect the first steering axis 120, although such a configuration is not required. In some embodiments, the first rotational axis 144 bisects the first steering axis 120. In some embodiments, the first rotational axis 144 is positioned in front of the first steering axis 120, meaning that the location where the first rotational axis 144 is nearest the first steering axis 120 is positioned away from the center of the frame 104 as compared to the first steering axis 120. In some embodiments, the first rotational axis 144 is positioned behind the first steering axis 120, meaning that the location where the first rotational axis 144 is nearest the first steering axis 120 is positioned closer to the center of the frame 104 as compared to the first steering axis 120.

Both (e.g., all) wheels 140 in the first set of wheels 108 may rotate about the first rotational axis 144 and pivot about the first steering axis 120. In some embodiments, movement of one wheel 140 (e.g., the left wheel 140) in the first set of wheels 108 about the first steering axis 120 is matched by a corresponding movement of the other wheel 140 (e.g., the right wheel 140) in the first set of wheels 108. It should be appreciated that each wheel 140 in the first set of wheels 108 may be driven independently meaning that one wheel 140 in the first set of wheels 108 may be driven forward while another wheel 140 in the first set of wheels 108 is driven backward or not driven at all. It may also be possible to drive each wheel 140 in the first set of wheels 108 at different speeds in the same direction or different directions (e.g., to induce turning of the first set of wheels 108 about the first steering axis 120).

Referring now to the second set of wheels 112, the second rotatable mount 136 may have the left wheel 140 mounted directly thereto on its left side while the right wheel 140 is mounted directly to the second rotatable mount 136 on its right side. Both wheels 140 may be self-propelled, meaning that each wheel 140 includes an internal motor and motor controller. In some embodiments, the motor controllers of each wheel 140 may be coordinated together, either by a shared logic or by a centralized coordination that is delegated to one of the wheel’s 140 controllers. Each wheel 140 in the second set of wheels 112 may be configured to rotate about a second rotational axis 148. The second rotational axis 148 may bisect the second steering axis 128, although such a configuration is not required. In some embodiments, the second rotational axis 148 bisects the second steering axis 128. In some embodiments, the second rotational axis 148 is positioned in front of the second steering axis 128, meaning that the location where the second rotational axis 148 is nearest the second steering axis 128 is positioned away from the center of the frame 104 as compared to the second steering axis 128. In some embodiments, the second rotational axis 148 is positioned behind the second steering axis 128, meaning that the location where the second rotational axis 148 is nearest the second steering axis 128 is positioned closer to the center of the frame 104 as compared to the second steering axis 128.

Both (e.g., all) wheels 140 in the second set of wheels 112 may rotate about the second rotational axis 148 and pivot about the second steering axis 128. In some embodiments, movement of one wheel 140 (e.g., the left wheel 140) in the second set of wheels 112 about the second steering axis 128 is matched by a corresponding movement of the other wheel 140 (e.g., the right wheel 140) in the second set of wheels 112. It should be appreciated that each wheel 140 in the second set of wheels 112 may be driven independently meaning that one wheel 140 in the second set of wheels 112 may be driven forward while another wheel 140 in the second set of wheels 112 is driven backward or not driven at all. It may also be possible to drive each wheel 140 in the second set of wheels 112 at different speeds in the same direction or different directions (e.g., to induce turning of the second set of wheels 112 about the second steering axis 128).

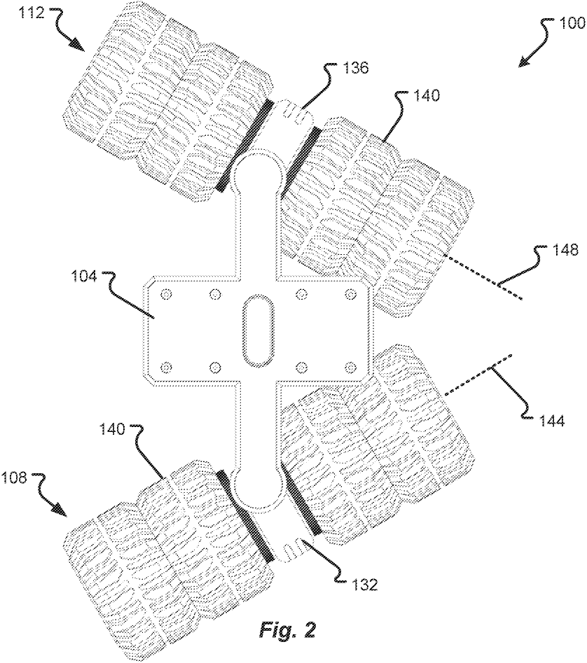

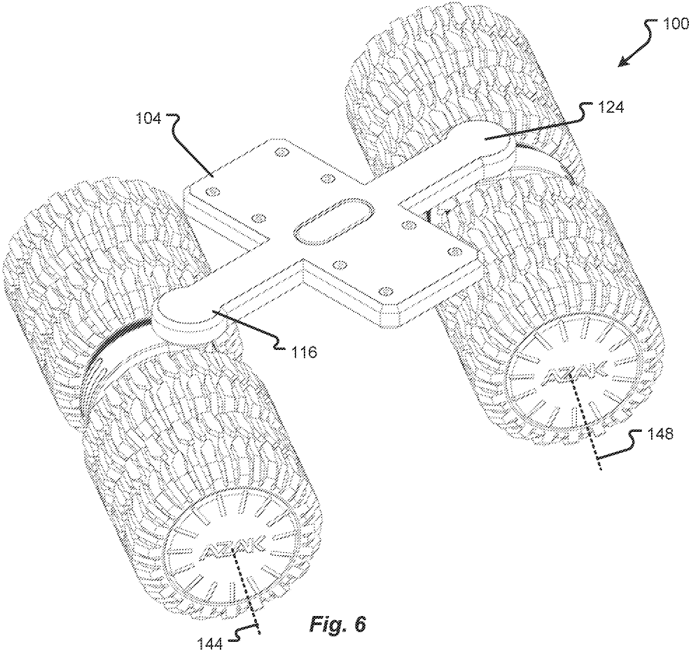

As can be seen in FIGS. 2-6, the first set of wheels 108 and second set of wheels 112 may be turned independent of one another about their respective steering axis. It may also be possible to coordinate steering of the first set of wheels 108 and second set of wheels 112 such that the vehicle 100 can be moved forward, laterally, or combinations thereof. An example of a steering configuration where the vehicle 100 can be moved laterally is shown in FIG. 6, where both the first set of wheels 108 and second set of wheels 112 are not pointed forward, but are both steered laterally with respect to the main axis of the frame 104. In other words, the vehicle 100 does not necessarily need to drive straight forwards or backwards. Additionally, because the wheels 140 in a set of wheels (either first set of wheels 108 or second set of wheels 112) rotate about a common steering axis (e.g., either first steering axis 120 or second steering axis 128), it may be possible to turn a set of wheels without invoking a skid/skipping as is known in traditional skid steering systems.

Specifically, as an example, the first set of wheels 108 may be rotated about the first steering axis 120 while the rest of the vehicle 100 (e.g., the frame 104 and the second set of wheels 112) remain stationary. This type of motion is made possible by having one of the wheels 140 in the first set of wheels 108 rotate in a first direction (e.g., forward) while the other wheel 140 in the first set of wheels 108 rotates in a second/opposite direction (e.g., backward) at the same speed as the wheel 140 rotating in the first direction. If the first rotational axis 144 is aligned with the first steering axis 120, then no skidding will be required to move the first set of wheels 112 even if the rest of the vehicle 100 remains stationary. Such a movement may facilitate high maneuverability of the vehicle 100, especially in tight spaces where a small turning radius is beneficial. Similar motions may be achieved with the second set of wheels 112. As noted above, rotation and steering of the first set of wheels 108 and second set of wheels 112 may be coordinated, but each wheel 140 in the set of wheels 108, 112 may be independently driven.

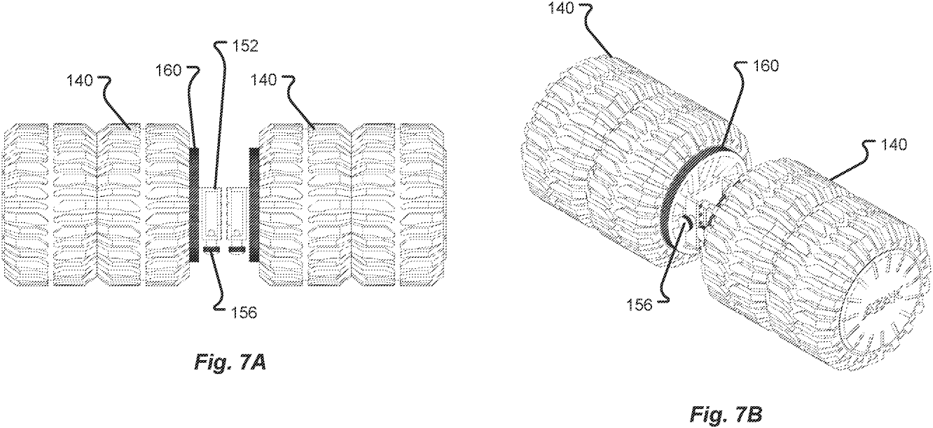

Referring now to FIGS. 7A - 8B, additional details of the wheels 140 will be described in accordance with at least some embodiments of the present disclosure. One or more wheels 140 provided on the vehicle 100 may be configured as shown. The wheels 140 may include a mounting interface 152, which may provide mechanical and/or electrical mechanisms for attaching the wheel 140 to a rotatable mount (e.g., the first rotatable mount 132 or second rotatable mount 136). In some embodiments, the mounting interface 152 may include one or more physical limiters 156. The physical limiters 156 may be configured to interface with a post or stop on the frame 104 that contacts the physical limiters 156. In some embodiments, the physical limiters 156 may include a physical post or the like along with a bumper that physically contacts a post of stopper of the frame 104. The physical limiter 156 may help to ensure that the wheel 140 or set of wheels 108, 112, does not rotate about the steering axis 120, 128 more than a predetermined amount.

The mounting interface 152 may be configured to physically attach to the rotatable mount 132, 136. The wheels 140 may also include bearings 160 that facilitate rotation around the rotational axes 140, 148. In some embodiments, the bearings 160 may also include gears or the like that translate rotational motion of a motor into rotational motion of the wheels 140. The bearings 160 may also support the physical weight of the frame 104 and loads placed upon the frame, while still maintaining rotational movement of the wheels around the rotational axes 144, 148.

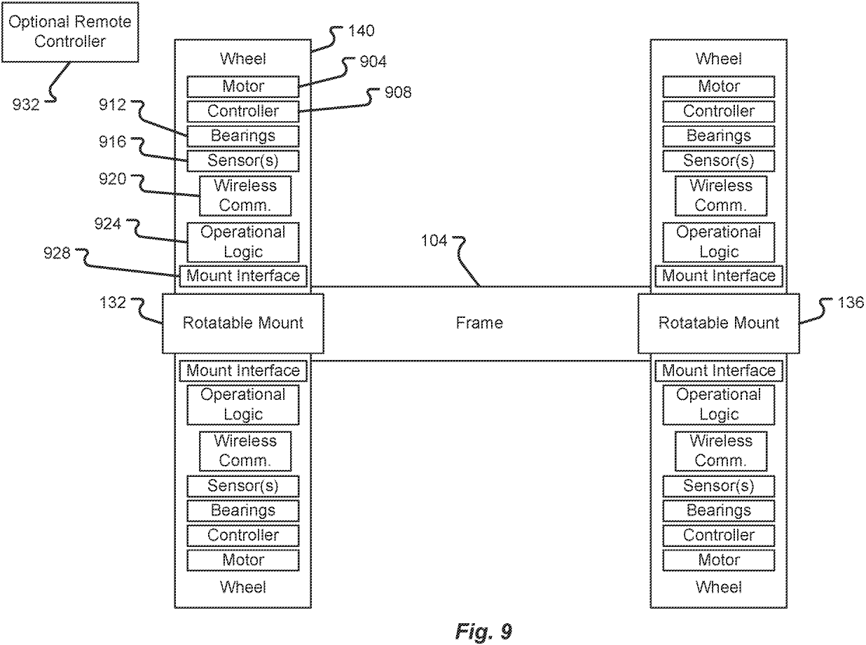

With reference now to FIG. 9, additional details of the components of the wheels 140 will be described in accordance with at least some embodiments of the present disclosure. One, some, or all of the wheels 140 may include a motor 904, a controller 908, bearings 912, sensor(s) 916, a wireless communication module 920, operational logic 924, and a mount interface 928.

The mount interface 928 may be similar or identical to the mount interface 152. The mount interface 928 may provide a mechanical connection between the rotatable mount 132, 136 and the wheel 140. In some embodiments, the mount interface 928 may include bolts, fasteners, or the like that physically attach the wheel 140 to the rotatable mount 132, 136. Whereas the rotatable mounts 132, 136 are configured to rotate about the steering axes 120, 128, the mount interface 928 may be configured to attach to the rotatable mounts 132, 136 and facilitate rotation of the wheels 140 around the rotational axes 144, 148. The mount interface 928 may include the bearings 912, which may be similar or identical to bearings 160.

The motor 904 may include any device or collection of devices that translate energy into motion. In some embodiments, the motor 904 may generate rotational motion of one or more gears, that is converted into rotational motion of the wheel 140. The motor 904 may include, without limitation, a servo motor, a direct drive motor, a linear motor, an AC motor, a DC motor, a stepper motor, or the like. The motor 904 may be operated by the controller 908, which provides input signals to the motor 904. The controller 908 may be responsive to control signals received from a remote controller 932 and/or control signals received from internal operational logic 924.

In some embodiments, the operational logic 924 may include instructions and/or machine learning models that facilitate autonomous operation of the vehicle 100. The operational logic 924 may alternatively or additionally include logic that facilitates coordination of the wheel’s 140 operation with operation of other wheels 140 on the vehicle 100. For example, all of the wheels 140 may include instructions from the remote controller 932 to make a turn in a particular direction. The operational logic 924 of each wheel 140 may convert the instructions received from the remote controller 932 into specific motor control instructions for the appropriate wheel 140 (i.e., some wheels 140 may rotate in one direction while other wheels may rotate in another direction). Alternatively or additionally, the operational logic 924 of each wheel 140 may communicate with operational logic 924 of other wheels 140 to coordinate motor 904 motion and cohesively control the vehicle 100. As mentioned above, the operational logic 924 may include machine learning models that facilitate autonomous or semi-autonomous operation of the vehicle 100. Inputs for the operational logic 924 may include inputs received from one or more sensors 916 on the wheels 140. Other inputs for the operational logic 924 may include inputs received from sensors on the frame 104. Examples of the sensors 916 that may be included in the wheels 140 and/or frame 104 are proximity sensors, motion sensors, accelerometers, force sensors, LIDAR sensors, image sensors, speed sensors, rotation sensors, etc.

It should be appreciated that the operational logic 924 may be incorporated into the controller 908 of the wheels 140. While depicted as part of the wheels 140, it should also be appreciated that the operational logic 924 and/or controller 908 functions may be provided by a component or collection of components that are mounted on the frame 104. For instance, motor control signals may be initiated by or coordinated with a controller 908 and/or operational logic 924 that is executed by a processor, CPU, GPU, etc., that is mounted on the frame 104. Said another way, the controller(s) 908 of the motors 904 may be contained within the wheels 140 or external to the wheels 140 (e.g., on the frame 104).

Regardless of its position or distribution across the vehicle 100, the controller 908 may utilize the operational logic 924 to process inputs from the sensor(s) 916 to determine which control signals should be generated and sent to the motor 904. As mentioned above, the controller 908 may respond to control signals received from a remote controller 932, which may be received via a wireless communication module 920. As an example, the wireless communication module 920 may include an antenna and corresponding driver that converts wireless controls signals received from the remote controller 932 into control signals that are provided to the controller 908. The controller 908 may then generate control signals for the motor 904, which will cause the motor 904 to rotate in a particular direction at a particular speed. Alternatively or additionally, the wireless communication modules 920 of each wheel 140 may enable wireless communications between wheels 140. For instance, one wheel 140 may include a primary controller 908 that communicates control signals to other wheels 140 via the wireless communication modules 920. In this way, operation of the wheels 140 may be coordinated even though each wheel 140 includes its own controller 908 and motor 904. As can be appreciated the controller 908 may be implemented using a microprocessor and computer memory. Alternatively or additionally, the controller 908 may be implemented using a Field Programmable Gate Array (FPGA), an Application Specific Integrated Circuit (ASIC), or the like.

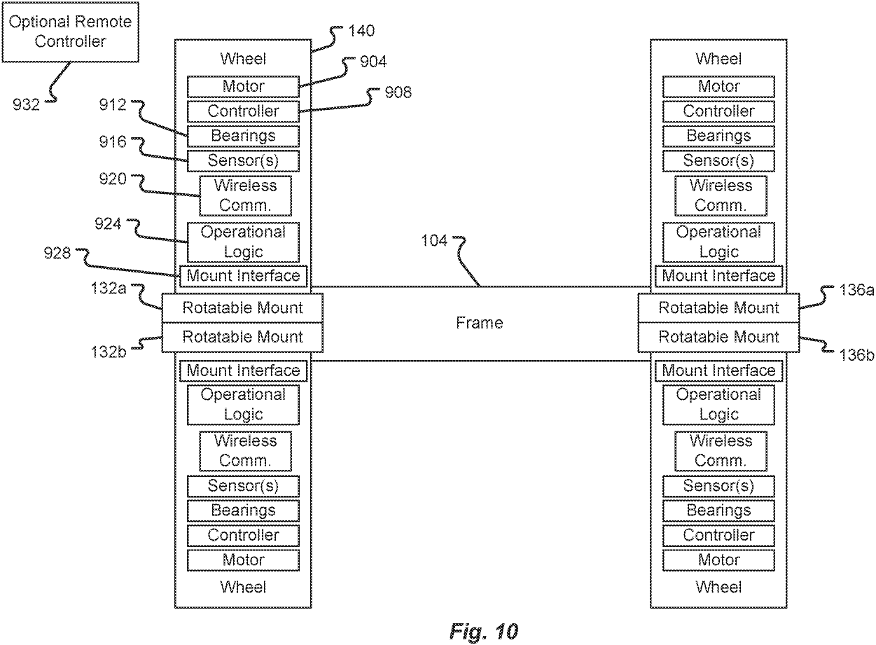

With reference now to FIG. 10, an alternative arrangement of components for a vehicle 100 will be described in accordance with at least some embodiments of the present disclosure. Similar to the configuration of FIG. 9, separate wheels 140 may be independently connected to the frame 104. One, some, or all of the wheels 140 may include a motor 904, a controller 908, bearings 912, sensor(s) 916, a wireless communication module 920, operational logic 924, and a mount interface 928.

The configuration of FIG. 10 is different from that of FIG. 9 in that each wheel 140 is independently connected to the frame 104 by a separate rotatable mount. Specifically, FIG. 10 illustrates a configuration where four wheels 140 are connected to the frame 104 by four rotatable mounts 132a, 132b, 136a, 136b, respectively. In some embodiments, each rotatable mount may have its own axis of rotation. In some embodiments, each rotatable mount may support connection with a single wheel 140. In this configuration, each wheel 140 may be configured to independently move and rotate relative to the frame 104, meaning that one wheel 140 may rotate about its mount while other wheels remain motionless or rotate in a different direction.

Because the wheels 140 may be independently moveable, it may be desirable to coordinate wheel motion 140 or track wheel 140 motion of each wheel 140 relative to other wheels 140. In some embodiments, if one wheel 140 is rotating independently of other wheels 140, then motion of the vehicle 100 may be prohibited until such time as all other wheels 140 have been properly and safely positioned to enable movement of the vehicle 100 that will not result in damage to the vehicle 100 or components thereof. For instance, it may be possible to rotate two rotatable mounts (e.g., mount 132a and mount 132b) independently and track the position of each wheel 140 connected thereto. The vehicle 100 may not be allowed to move (e.g., rotate, turn, drive forward, drive backward, etc.) until both of the wheels 140 connected to the mounts 132a, 132b are in predetermined positions (e.g., have their axes aligned, have appropriate relative positions to support spinning, etc.). This verification may be supported by tracking wheel 140 position based on feedback from sensors 916 and/or by receiving position data from each wheel’s 140 controller 908 at a master controller. Enabling independent rotation of each wheel 140 relative to the frame 104 makes spinning and maneuvering possible without requiring frame 104 motion and without requiring excessive torque from the motors 904 of any wheel 140.

Specific details were given in the description to provide a thorough understanding of the embodiments. However, it will be understood by one of ordinary skill in the art that the embodiments may be practiced without these specific details. Additionally, the Figures do not depict well-known features that may be needed to create a working vehicle so as not to obscure the embodiments in unnecessary detail.

What is claimed is:

1. A vehicle, comprising:
a frame; and
a first set of wheels configured to rotate about a first rotational axis, wherein each wheel in the first set of wheels is independently motor controlled, wherein the first set of wheels are pivotably mounted to the frame such that the first set of wheels spin about a first steering axis, and wherein the first steering axis is orthogonal to the first rotational axis.

2. The vehicle of claim 1, further comprising:
a second set of wheels configured to rotate about a second rotational axis, wherein the second set of wheels are pivotably mounted to the frame such that the second set of wheels spin about a second steering axis, wherein the second steering axis is orthogonal to the second rotational axis.

3. The vehicle of claim 2, wherein the first rotational axis is parallel to the second rotational axis.

4. The vehicle of claim 3, wherein the second rotational axis is orthogonal to the first steering axis and wherein the first rotational axis is orthogonal to the second steering axis.

5. The vehicle of claim 1, wherein the first rotational axis bisects the first steering axis.

6. The vehicle of claim 1, wherein the first rotational axis does not bisect the first steering axis.

7. The vehicle of claim 1, wherein the first set of wheels include a first wheel and a second wheel, wherein the first wheel includes a first motor and a first controller, wherein the second wheel includes a second motor and a second controller, wherein the first controller provides first control signals to the first motor, and wherein the second controller provides second control signals to the second motor.

8. The vehicle of claim 7, wherein the first controller and the second controller operate autonomously.

9. The vehicle of claim 7, wherein the first controller and the second controller coordinate with one another and operate based on control signals received from a remote controller.

10. The vehicle of claim 1, wherein a first wheel in the first set of wheels is driven in a first direction by a first motor and a second wheel in the first set of wheels is driven in a second direction by a second motor that opposes the first direction to rotate the first set of wheels about the first steering axis without imparting motion to the frame.

11. The vehicle of claim 1, further comprising:
a limiter that prohibits the first set of wheels from pivoting more than a predetermined amount about the first steering axis.

12. The vehicle of claim 1, wherein each wheel in the first set of wheels is connected to the frame by a common rotatable mount.

13. The vehicle of claim 1, wherein each wheel in the first set of wheels is connected to the frame by a different rotatable mount.

14. A steering system for a vehicle, the steering system comprising:
a rotatable mount connected to a frame of the vehicle, wherein the rotatable mount pivots about a steering axis; and
a first set of wheels that are independently motor controlled and connected to the rotatable mount, wherein the first set of wheels are configured to rotate about a rotational axis that is orthogonal to the steering axis.

15. The steering system of claim 14, wherein the first set of wheels include a first wheel and a second wheel, both of which rotate about the rotational axis.

16. The steering system of claim 15, wherein the first wheel spins in a first direction and the second wheel spins in a second direction, opposite the first direction, to cause the first set of wheels to pivot about the steering axis.

17. The steering system of claim 14, further comprising:
a second rotatable mount connected to the frame, wherein the second rotatable mount pivots about a second steering axis;
a second set of wheels connected to the second rotatable mount, wherein the second set of wheels are configured to rotate about a second rotational axis that is orthogonal to the second steering axis.

18. The steering system of claim 14, further comprising:
a sensor; and
a controller that receives input from the sensor and controls rotation of at least one wheel in the first set of wheels based on the input received from the sensor.

19. The steering system of claim 18, wherein the sensor provides input to the controller indicating an amount by which the first set of wheels has pivoted about the steering axis and wherein the sensor comprises at least one of a proximity sensor, a motion sensor, an accelerometer, a force sensor, a LIDAR sensor, an image sensor, a speed sensor, and a rotation sensor.

20. The steering system of claim 14, wherein the first set of wheels comprise at least a first motor and a second motor that are independently controlled by a first controller and a second controller, respectively.
